(19) United States
(12) Patent Application Publication
(10) Pub. No.: US 2008/0178301 A1
(43) Pub. Date: Jul. 24, 2008

(54) DATA RECORDING SYSTEM AND METHOD

(75) Inventor: Shang-Nien Tsai, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/625,843

(22) Filed: Jan. 23, 2007

(51) Int. Cl. G06F 7/04

(52) U.S. Cl. 726/32

(57) ABSTRACT

A data recording system and a method of preventing copying data from a recording medium are disclosed. The method comprises an optical recorder receiving modulated bits encoded by EFM/EFM+ (Eight-to-Fourteen Modulation/Eight-to-Fourteen Modulation Plus), the optical recorder converting modulated bits to channel bits, and recording the channel bits to the recording medium. The modulated bits and the channel bits are readable by the optical recorder.

### BACKGROUND OF THE INVENTION

1. Field of the Invention

The invention relates to data recording systems, and more particularly to a CD/DVD recording system and method.

2. Description of the Related Art

In compact disc (CD) or digital versatile disc (DVD) applications, data to be recorded is transferred from the data source to the recording systems disc in data symbols. The CD or DVD recording systems then generate header and synchronization information, control bytes, identification data, and copyright management information, perform data processing including data scrambling and error correction code generation on the data symbols. The data symbols are then modulated using EFM (Eight-to-Fourteen Modulation) for CD and EFM+ (Eight-to-Fourteen Modulation Plus) for DVDs to produce channel bits for recoding on CDs and DVDs.

Many data copy protection methods focus on manipulating channel bits, such that when copying data from a source to a destination disc, the channel bits to the destination disc are different from the channel bits of the source, copying data from the source disc is thereby prevented. Such processing from data byte to channel bit is, however complicated.

Further, conventional CD or DVD recording systems are specification dependent, thus, systems conforming to older specifications are incompatible with newer ones.

An apparatus and method for creating an optical disc on which data cannot be illegally reproduced is thus desirable.

### BRIEF SUMMARY OF THE INVENTION

A detailed description is given in the following embodiments with reference to the accompanying drawings.

An exemplary embodiment of a method of preventing copying data from a recording medium is disclosed. The method comprises an optical recorder receiving EFM/EFM+ (Eight-to-Fourteen Modulation/Eight-to-Fourteen Modulation Plus) modulated encoded bits. The optical recorder generates the channel bits according to the modulated bits, and records the channel bits to the recording medium. The modulated bits and the channel bits are readable by the optical recorder.

An exemplary embodiment of a data recording system comprises an optical recorder. The optical recorder receives EFM/EFM+ (Eight-to-Fourteen Modulation/Eight-to-Fourteen Modulation Plus) modulated encoded bits. The system generates the channel bits according to the modulated bits, and records the channel bits to the recording medium. The modulated bits and the channel bits are readable by the optical recorder.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary optical recording system according to the invention.

FIG. 2 is a block diagram of another exemplary optical recording system according to the invention.

FIG. 3 is a block diagram of yet another exemplary optical recording system according to the invention.

FIG. 4 is a block diagram of still another exemplary optical recording system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The scope of the invention may include, but is not limited to, optical recorders adapted to optical recording standards including CD-R, CD-RW, DVD-R/RW, DVD+R/RW, DVD-ROM, DVD-RAM, HD DVD, and blu-ray.

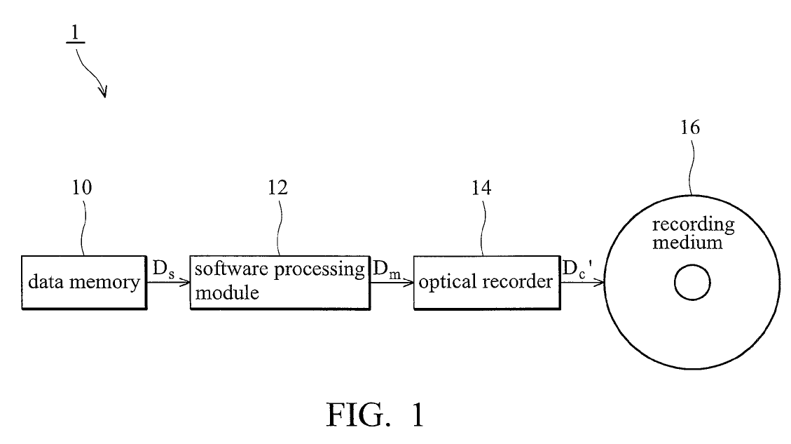

FIG. 1 is a block diagram of an exemplary optical recording system according to the invention, comprising data memory 10, software processing module 12, optical recorder 14 and recording medium 16. Data memory 10 is coupled to software processing module 12, optical recorder 14, and subsequently to recording medium 16.

Data symbols Ds are stored in data memory 10. Depending on a specific specification, software processing module 12 reads data symbols Ds of one byte from data memory 10, determines header and synchronization information, control byte, identification data, copyright management information, divides the attached data symbols Ds into blocks, performs error correction code (ECC) protection according thereto, and executes channel modulation such as EFM or EFM+ to generate modulated data Dm. EFM belongs to the class of DC-free Run-Length-Limited (RLL) codes because it ensures that the power density spectrum of the encoded channel bit sequence vanishes at the low-frequency end and both the minimum and maximum number of consecutive bits of the same kind are within specified bounds. Modulated bits Dm may be in the form of channel bits or run-length code. Instead of conventional data symbols Ds, modulated bits Dm are passed to optical recorder 14, converted to channel bits Dc to write on recording medium 16, depicted in FIG. 1 as an optical disc. Recording medium 16 may be a CD-R, CD-RW, DVD-R/RW, DVD+R/RW, DVD-ROM, DVD-RAM, HD DVD, or blu-ray disc. Channel bits Dc may be a Non-Return-to-Zero-Inverted (NRZI) signal.

Channel bits Dc on recording medium 16 are readable by conventional CD/DVD players and are not label flash or light scribe data. Run-length code is a form of data compression in which runs of channel bits sequence are represented as a single data value and count, rather than as the original sequence. For example, a channel bit sequence 1001000010010001 may be represented by run-length code (2, 4, 2, 3).

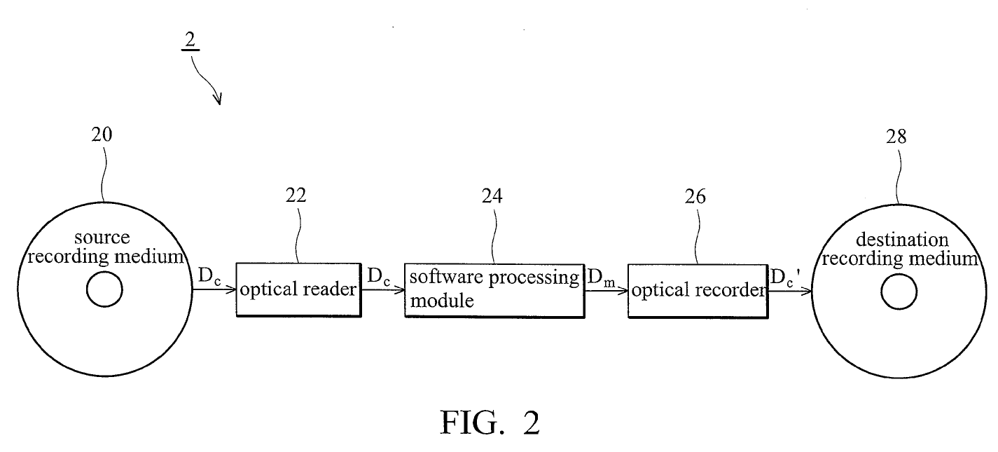

FIG. 2 is a block diagram of another exemplary optical recording system according to the invention, comprising source recording medium 20, optical reader 22, software processing module 24, optical recorder 26, and destination recording medium 28. Source recording medium 20 is coupled to optical reader 22, software processing module 24, optical recorder 26, and subsequently to destination recording medium 28.

Source recording medium 20 is an optical disc holding channel bits Dc to be copied to destination recording medium 28. Optical reader 22 reads and transmits channel bit Dc from source recording medium 20 to software processing module 24, where additional data processing such as data buffering is performed and resultant modulated bit Dm are delivered to optical recorder 26. Modulated bits Dm may be in the form of channel bits or run-length code. Optical recorder 26 then writes channel bit Dc to destination recording medium 28. Source and destination recording medium 20 and 28 may be a CD-R, CD-RW, DVD-R/RW, DVD+R/RW, DVD-ROM, DVD-RAM, HD DVD, or blu-ray disc. Channel bits Dc may be a Non-Return-to-Zero-Inverse (NRZI) signal.

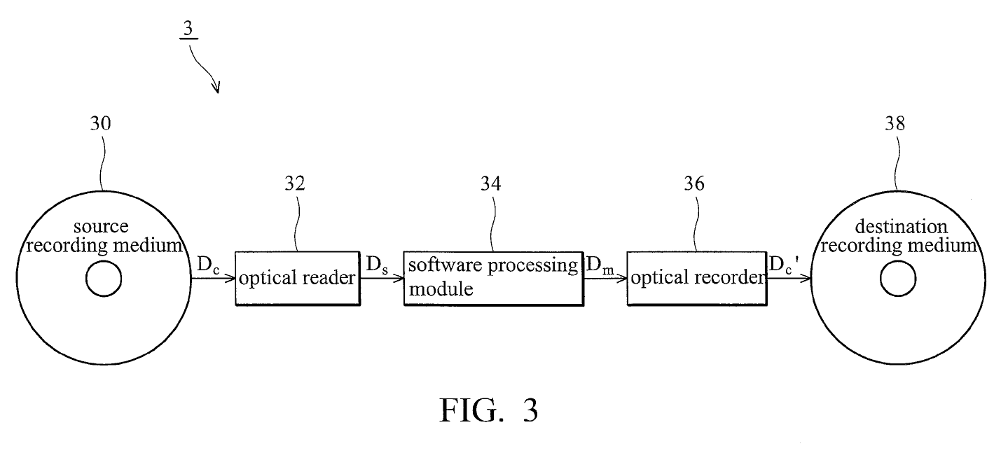

FIG. 3 is a block diagram of yet another exemplary optical recording system according to the invention, comprising source recording medium 30, optical reader 32, software processing module 34, optical recorder 36, and destination recording medium 38. Source recording medium 30 is coupled to optical reader 32, software processing module 34, optical recorder 36, and subsequently to destination recording medium 38.

Source recording medium 30 is an optical disc containing channel bits Dc to be copied to destination recording medium 38. Optical reader 32 reads and demodulates channel bit Dc from source recording medium 30 to produce data symbols Ds, subsequently delivered to software processing module 34 for data error correction and channel modulation emulation to produce modulated bits Dm. Methods of emulating EFM/EFM+ channel modulation and controlling digital sum value (DSV) are disclosed in U.S. Pat. Nos. 4,603,413, 5,699,434, 5,828,754, 6,278,386, 6,778,104, and 7,023,785. Modulated bits Dm may be in the form of channel bits or run-length code. Next, modulated bits Dm are delivered to optical recorder 36, which in turn converts and writes modulated bits Dm into channel bits Dc to destination recording medium 38, depicted as an optical disc. Source and destination recording medium 30 and 38 may be a CD-R, CD-RW, DVD-R/RW, DVD+R/RW, DVD-ROM, DVD-RAM, HD DVD, or blu-ray disc. Channel bits Dc may be a Non-Return-to-Zero-Inverse (NRZI) signal.

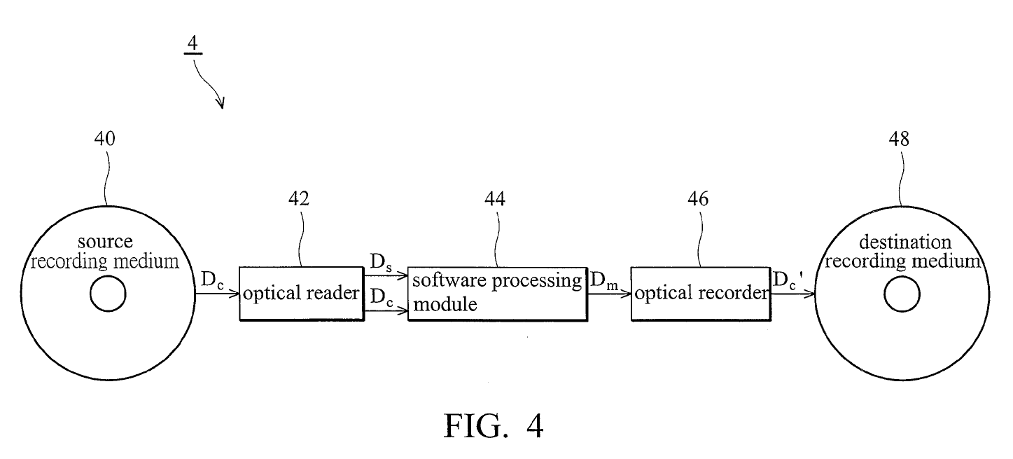

FIG. 4 is a block diagram of still another exemplary optical recording system according to the invention, comprising source recording medium 40, optical reader 42, software processing module 44, optical recorder 46, and destination recording medium 48. Source recording medium 40 is coupled to optical reader 42, software processing module 44, optical recorder 46, and subsequently to destination recording medium 48.

Source recording medium 40 is an optical disc containing channel bits Dc to be copied to destination recording medium 48. Optical reader 42 reads and demodulates channel bits Dc from source recording medium 40 to produce data symbols Ds. Next, data symbols Ds in conjunction with channel bits Dc are delivered to software processing module 44 to produce modulated data Dm in the form of channel bits or run-length code. Next, rather than conventional channel bits Dc, modulated bits Dm are delivered to optical recorder 46, which in turn converts and writes modulated bits Dm into channel bits Dc to destination recording medium 48, as depicted as an optical disc. Source and destination recording medium 40 and 48 may be a CD-R, CD-RW, DVD-R/RW, DVD+R/RW, DVD-ROM, DVD-RAM, HD DVD, or blu-ray disc. Channel bits Dc may be a Non-Return-to-Zero-Inverse (NRZI) signal.

A method of preventing copying data from a recording medium, incorporating the optical recording system in FIGS. 1 through 4 is disclosed.

The method comprises optical recorder 14 receiving modulated bits Dm encoded by EFM/EFM+, converting modulated bits Dm to channel bits Dc, and recording the channel bits to recording medium 16.

Referring to FIG. 1, the method may further comprise software processing module 12 reading data symbols Ds in data memory 10, and encoding data symbols Ds to modulated bits Dm by EFM/EFM+.

Referring to FIG. 2, the method may further comprise optical reader 22 reading modulated bits Dm from source recording medium 20.

Referring to FIG. 3, the method may further comprise optical reader 32 converting channel bits Dc to data symbols Ds, performing error correction to the data symbols Ds, and encoding the corrected data symbols to modulated bits Dm by EFM/EFM+.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of preventing copying data from a recording medium, comprising:
receiving modulated bits encoded by EFM/EFM+;
generating the channel bits according to the modulated bits; and
recording the channel bits to the recording medium;
wherein the modulated bits and the channel bits are readable by the optical recorder.

2. The method of claim 1, further comprising software encoding source data symbols into the modulated bits by EFM/EFM+.

3. The method of claim 1, further comprises reading the modulated bits from a source recording medium.

4. The method of claim 3, further comprising:
converting the modulated bits to data symbols;
performing error correction to the data symbols; and
encoding the corrected data symbols to the modulated bits by EFM/EFM+.

5. The method of claim 1, wherein the modulated bits are run-length codes.

6. The method of claim 1, wherein the modulated bits are channel bits.

7. A data recording system, preventing copying data from a recording medium, comprising:
an optical recorder, receiving modulated bits encoded by EFM/EFM+, converting modulated bits to channel bits, and recording the channel bits to the recording medium; and
wherein the modulated bits and the channel bits are readable by the optical recorder.

8. The data recording system of claim 7, further comprising an software processing module, coupled to the optical recorder, for encoding source data symbols into the modulated bits by EFM/EFM+.

9. The data recording system of claim 7, further comprising an optical reader, coupled to the optical recorder, for reading the modulated bits from a source recording medium.

10. The data recording system of claim 9, further comprising an software processing module, coupled between the optical reader and the optical recorder, for converting the modulated bits to data symbols, performing error correction to the data symbols, and encoding the corrected data symbols to EFM/EFM+ modulated bits

11. The data recording system of claim 7, wherein the modulated bits are run-length codes.

12. The data recording system of claim 7, wherein the modulated bits are channel bits.
